(19) United States
(12) Patent Application Publication
(10) Pub. No.: US 2025/0206577 A1
(43) Pub. Date: Jun. 26, 2025

(54) CRANE

(71) Applicant: SUMITOMO HEAVY INDUSTRIES, LTD., Tokyo (JP)

(72) Inventors: Yasuhiro YAMAMOTO, Yokosuka-shi (JP); Chunnan WU, Yokosuka-shi (JP); Keita NAKAMORI, Yokosuka-shi (JP); Hisashi OSUMI, Tokyo (JP)

(21) Appl. No.: 18/986,500

(22) Filed: Dec. 18, 2024

(30) Foreign Application Priority Data
Dec. 22, 2023 (JP) 2023-216789

(51) Int. Cl. B66C 13/06

(52) U.S. Cl. CPC B66C 13/063

(57) ABSTRACT

A crane includes a boom that suspends a suspended load, a drive device that drives the boom, and a control unit that controls the drive device, the control unit inputting a control command including a pattern for swing suppression to the drive device, to cause the drive device to execute a swing suppression drive, and, when a value of the control command is converted into a command value of acceleration of the boom, the pattern for swing suppression includes a modified triangular wave including, in consecutive order, a first gradient portion that changes with a predetermined gradient in either a positive or negative direction, an offset portion in which the command value is displaced in a direction opposite to the change in the first gradient portion, and a second gradient portion that changes with a predetermined gradient in the direction opposite to the change in the first gradient portion.

### CROSS-REFERENCE TO RELATED APPLICATIONS

This application claims priority to Japanese Patent Application No. 2023-216789, filed on Dec. 22, 2023, which is incorporated by reference herein in its entirety.

### BACKGROUND

### Technical Field

A certain embodiment of the present invention relates to a crane.

### Description of Related Art

The related art discloses a control device that reduces a swing of a load of a crane by inputting a speed command obtained by numerically integrating a predetermined acceleration pattern to a drive device.

### SUMMARY

According to an embodiment of the present invention, there is provided a crane including: a boom that suspends a suspended load; a drive device that drives the boom such that the suspended load moves in a first direction; and a control unit that controls the drive device, in which the control unit inputs a control command including a pattern for swing suppression to the drive device, to cause the drive device to execute a swing suppression drive of reducing a swing of the suspended load, and, when a value of the control command is converted into a command value of acceleration of the boom, the pattern for swing suppression includes a modified triangular wave including, in consecutive order, a first gradient portion that changes with a predetermined gradient in either a positive or negative direction, an offset portion in which the command value is displaced in a direction opposite to the change in the first gradient portion, and a second gradient portion that changes with a predetermined gradient in the direction opposite to the change in the first gradient portion.

According to another embodiment of the present invention, there is provided a crane including: a boom that suspends a suspended load; and a drive device that drives the boom such that the suspended load moves in a first direction, in which the drive device executes a swing suppression drive in which a jerk of the boom changes in a pattern of a plurality of rectangular waves, to reduce a swing of the suspended load.

### BRIEF DESCRIPTION OF THE DRAWINGS

FIG. 1 is a block diagram showing a crane according to the present embodiment.

FIGS. 2A and 2B are time charts showing an example of a movement of a boom and an example of a control command in a swing suppression drive in Embodiment 1, respectively.

FIG. 3 is a phase plane diagram showing the swing suppression drive of FIG. 2.

FIGS. 4A-1 and 4A-2 and 4B-1 and 4B-2 are time charts showing examples of a movement of a boom and examples of a control command in a swing suppression drive in Embodiment 2, respectively.

FIG. 5 is a phase plane diagram showing the swing suppression drive of FIGS. 4A-1 to 4B-2.

FIG. 6 is a diagram showing a swing of a suspended load caused by the swing suppression drive of FIGS. 4A-1 to 4B-2.

FIG. 7A and FIG. 7B are time charts showing an example of a movement of a boom and an example of a control command in a swing suppression drive in Embodiment 3, respectively, and FIG. 7C is a phase plane diagram showing an example of a movement of a phase point.

FIG. 8A and FIG. 8B are time charts showing an example of a movement of a boom and an example of a control command in a swing suppression drive in Embodiment 4, respectively, and FIG. 8C is a phase plane diagram showing an example of a movement of a phase point.

FIGS. 9A to 9C are time charts showing a swing suppression drive in Embodiment 5 in consideration of an effect of a centrifugal force.

FIGS. 10A and 10B are time charts showing an example of a motion of a suspended load via the swing suppression drive in Embodiment 5 and an example of the motion of the suspended load when the swing suppression drive without considering the effect of the centrifugal force is performed, respectively.

### DETAILED DESCRIPTION

However, in the control device in the related art, there is a problem in that an expected swing suppression effect cannot be obtained due to a response delay of the drive device.

It is desirable to provide a crane that can effectively correct a response delay of a drive device and implement a more accurate swing suppression drive.

Hereinafter, embodiments of the present invention will be described in detail with reference to the accompanying drawings.

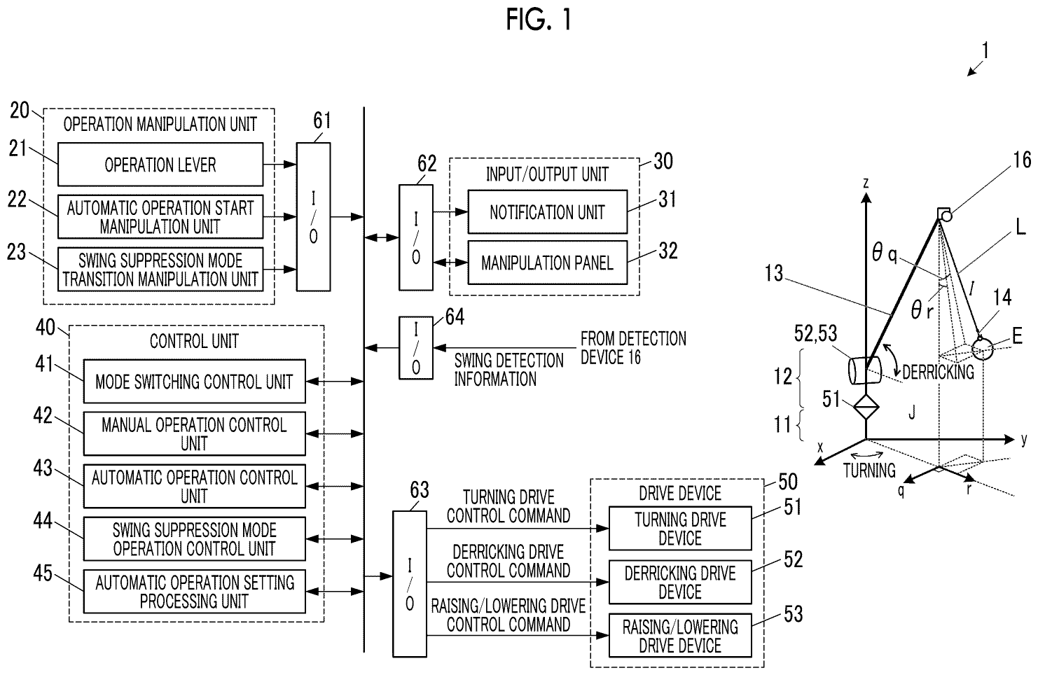

FIG. 1 is a block diagram showing a crane according to the present embodiment. A crane 1 according to the present embodiment includes a lower structure 11, a rotating platform 12 that is driven to turn with respect to the lower structure 11, a boom 13 that is derricked with respect to the rotating platform 12, and a hook 14 that is suspended from the boom 13 via a wire rope L. Although FIG. 1 shows the lower structure 11 in a simplified manner, the lower structure 11 may be, for example, a traveling body such as a crawler, or may be a fixed structure.

The crane 1 further includes a detection device 16 such as a camera that detects a swing of a suspended load E, an operation manipulation unit 20 that can be manipulated by an operator, an input/output unit 30 that outputs information to the operator and that inputs information from the operator, a control unit 40 that performs operation control of the crane 1, and a drive device 50 that drives the boom 13. The operation manipulation unit 20, the input/output unit 30, and the control unit 40 may be disposed, for example, in a cab 2 and a control room 3 on the rotating platform 12. The detection device 16 transmits detection information (video data or the like) on the swing of the suspended load E to the control unit 40 via an I/O 64.

The operation manipulation unit 20 includes an operation lever 21 for manually performing a turning operation of the rotating platform 12, a derricking operation of the boom 13, and a raising/lowering operation of the hook 14. The turning of the rotating platform 12 corresponds to a turning of the boom 13. The operation manipulation unit 20 further includes an automatic operation start manipulation unit 22 for the crane 1 to transition to an automatic operation mode, and a swing suppression mode transition manipulation unit 23 for the crane 1 to transition to a swing suppression mode. The automatic operation mode is an operation mode in which information on a transport destination of the suspended load E is input in advance, and the turning operation and the derricking operation are automatically manipulated by operating the automatic operation start manipulation unit 22 in a state where the suspended load E is suspended, so that the suspended load E can be automatically moved to above the transport destination. The swing suppression mode is an operation mode in which a swing suppression operation of reducing the swing of the suspended load E is automatically performed. A manipulation signal of the operation lever 21, a manipulation signal of the automatic operation start manipulation unit 22, and a manipulation signal of the swing suppression mode transition manipulation unit 23 are transmitted to the control unit 40 via an I/O 61.

The input/output unit 30 includes a notification unit 31 that notifies the operator of information via display or sound, and a manipulation panel 32 through which the operator can input information via the manipulation. In addition, the control unit 40 includes an automatic operation setting processing unit 45 that inputs setting information (a movement start position of the suspended load E, a movement path of the boom 13, a movement end position of the suspended load E, and the like) on the automatic operation via the manipulation panel 32. The notification unit 31 receives a command from the control unit 40 via an I/O 62 to perform a notification operation. The manipulation panel 32 receives a display signal from the control unit 40 (more specifically, the automatic operation setting processing unit 45) via the I/O 62, and outputs a manipulation signal to the control unit 40 (more specifically, the automatic operation setting processing unit 45) via the I/O 62. There is a location where it is desired to avoid the passage of the boom 13 or to avoid the passage of the suspended load E and the wire rope L during the turning operation, and the information on the movement path of the boom 13 may be set in a case where the passage of the location can be avoided by changing a derricking angle of the boom 13. The information on the movement end position may have a format in which position information such as a coordinate position is directly input, or may have a format input by using a turning angle of the rotating platform 12 and the derricking angle of the boom 13. Alternatively, a format may be adopted in which the hook 14 is moved by a manual manipulation, the designation manipulation is performed to move the position of the hook 14 to the movement end position, and the position of the hook 14 at that time is input as the movement end position in the automatic operation mode.

The control unit 40 includes a mode switching control unit 41 that performs switching control of the operation mode, a manual operation control unit 42 that performs operation control of the crane 1 in a manual operation mode, an automatic operation control unit 43 that performs the operation control of the crane 1 in an automatic operation mode, a swing suppression mode operation control unit 44 that performs the operation control of the crane 1 in the swing suppression mode, and the automatic operation setting processing unit 45 that inputs the setting information of the automatic operation via the manipulation panel 32. The control unit 40 is a computer including a central processing unit (CPU), a storage device that stores a control program, and an interface that inputs and outputs a signal between the control unit 40 and an external device (a component of the crane 1). The mode switching control unit 41, the manual operation control unit 42, the automatic operation control unit 43, the swing suppression mode operation control unit 44, and the automatic operation setting processing unit 45 may be software modules implemented by the CPU executing the control program. The control unit 40 exchanges a control command and information with the operation manipulation unit 20, the input/output unit 30, the detection device 16, and the drive device 50 via a bus and the I/Os 61 to 63.

The drive device 50 includes a turning drive device 51 that turns the boom 13, a derricking drive device 52 that derricks the boom 13, and a raising/lowering drive device 53 that raises and lowers the suspended load E.

The turning drive device 51 includes a rotating mechanism that rotatably supports the rotating platform 12, a first hydraulic motor that generates a rotational power of the rotating platform 12, a first control valve that controls a hydraulic pressure, and a first drive circuit that drives the first control valve in accordance with the control command from the control unit 40. The first hydraulic motor is rotationally driven by a pressure of a hydraulic oil discharged from a hydraulic pump and supplied via the first control valve. The first control valve changes an opening degree in response to a pilot signal from the first drive circuit, the pressure of the hydraulic oil supplied to the first hydraulic motor is changed in accordance with the opening degree, and a rotating motion (a rotation speed or a torque) of the first hydraulic motor is changed. The pilot signal is a hydraulic signal.

The derricking drive device 52 includes a pivoting mechanism that pivotably supports the boom 13 in a derricking direction, a wire rope that supports the boom via a mast, a derricking winch that winds and unwinds the wire rope, a second hydraulic motor that rotationally drives the derricking winch, a second control valve that controls a hydraulic pressure, and a second drive circuit that drives the second control valve in accordance with the control command from the control unit 40. The second hydraulic motor is rotationally driven by a pressure of a hydraulic oil discharged from a hydraulic pump and supplied via the second control valve. The second control valve changes an opening degree in response to a pilot signal from the second drive circuit, the pressure of the hydraulic oil supplied to the second hydraulic motor is changed in accordance with the opening degree, and a rotating motion (a rotation speed or a torque) of the second hydraulic motor is changed. The pilot signal is a hydraulic signal.

The raising/lowering drive device 53 includes a mechanism that supports the wire rope L engaged with the hook 14 to be capable of being unwound from and wound around a tip part of the boom 13, a raising/lowering winch that winds and unwinds the wire rope L, a third hydraulic motor that rotationally drives the raising/lowering winch, a third control valve that controls a hydraulic pressure, and a third drive circuit that drives the third control valve in accordance with the control command from the control unit 40. The third hydraulic motor is rotationally driven by a pressure of a hydraulic oil discharged from a hydraulic pump and supplied via the third control valve. The third control valve changes an opening degree in response to a pilot signal from the third drive circuit, the pressure of the hydraulic oil supplied to the third hydraulic motor is changed in accordance with the opening degree, and a rotating motion (a rotation speed or a torque) of the third hydraulic motor is changed. The pilot signal is a hydraulic signal.

The control unit 40 creates a turning drive control command, a derricking drive control command, and a raising/lowering drive control command in accordance with the manipulation of the operation lever 21 or in accordance with a result of calculation processing for automatic operation. The turning drive control command is a control command to designate a rotating motion (for example, a torque, a rotation speed, and the like) of the turning drive device 51. The derricking drive control command is a control command to designate a derricking motion (for example, a torque of the derricking winch, a rotating speed, and the like) of the boom 13 via the derricking drive device 52. The raising/lowering drive control command is a control command to designate a raising/lowering motion (for example, a torque and a rotation speed of the raising/lowering winch) of the hook 14 via the raising/lowering drive device 53. Then, the control unit 40 outputs these control commands to the first drive circuit of the turning drive device 51, the second drive circuit of the derricking drive device 52, and the third drive circuit of the raising/lowering drive device 53. Then, the first drive circuit to the third drive circuit control the respective pilot signals (hydraulic pressures) by performing, for example, feedforward-control and feedback-control such that the motion indicated by the control command occurs. With such control, the rotating motion, the derricking motion, and the raising/lowering motion in accordance with the control command output from the control unit 40 are implemented.

Meanwhile, even in a case where the control as described above is performed, it is difficult to set a response delay of the turning drive device 51, a response delay of the derricking drive device 52, and a response delay of the raising/lowering drive device 53 to zero. When a value of the control command of the turning drive device 51, a value of the control command of the derricking drive device 52, or a value of the control command of the raising/lowering drive device 53 is abruptly changed, a deviation occurs between the value of the control command and an actual motion. The value of the control command to designate the speed or the torque can be converted into a command value of the acceleration, which is a change rate of the command value of the speed.

In the present embodiment, each of the turning drive device 51, the derricking drive device 52, and the raising/lowering drive device 53 is driven by a hydraulic motor, and a configuration is shown in which the hydraulic motor is controlled via a control valve based on a pilot signal by hydraulic pressure. However, for example, a configuration may be adopted in which the pilot signal for controlling the opening degree of the control valve is an electric signal, or a configuration may be adopted in which an electric motor is used instead of the hydraulic motor. Also in the above-described configuration, the above-described response delay similarly occurs, and the deviation due to the response delay occurs between the command value and the actual motion when the value of the control command is abruptly changed.

With the crane 1 having the above-described configuration, the suspended load E can be suspended up from the ground by suspending the suspended load E on the hook 14 suspended from the tip part of the boom 13, and winding the wire rope L by using a driving force of the raising/lowering drive device 53. Thereafter, the rotating platform 12 and the boom 13 are turned by a driving force of the turning drive device 51, and the derricking angle of the boom 13 is changed by a driving force of the derricking drive device 52 when necessary, so that the suspended load E can be moved to a position above the transport destination. Then, the wire rope L is unwound by the driving force of the raising/lowering drive device 53, so that the suspended load E can be lowered to the transport destination. The suspended load E moves in a direction q via the turning of the boom 13, and the suspended load E moves in a direction r via the derricking of the boom 13. The direction q is a tangential direction of a turning circle of the tip part of the boom 13, and the direction r is a direction perpendicular and horizontal to the direction q, that is, a horizontal component of a direction in which the tip part of the boom 13 moves due to the derricking of the boom 13. Hereinafter, the direction q will be also referred to as a turning direction, and the direction r will be also referred to as a derricking direction.

### Embodiment 1

Subsequently, a swing suppression drive of Embodiment 1 when the suspended load E is transported in a first direction will be described. Embodiment 1 shows an example in a case where the first direction is the turning direction, and a change amount of a turning angle is relatively small to an extent that a centrifugal force can be ignored or a turning speed is small. The swing suppression drive is implemented by the automatic operation control unit 43 when the operator designates a transport destination point and then selects the automatic operation mode.

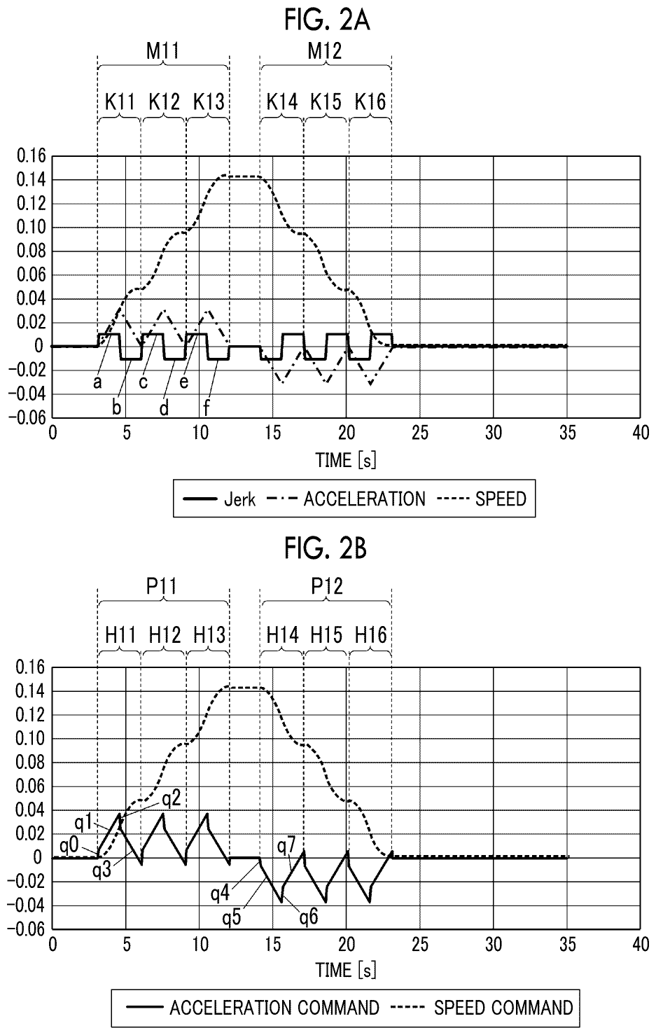

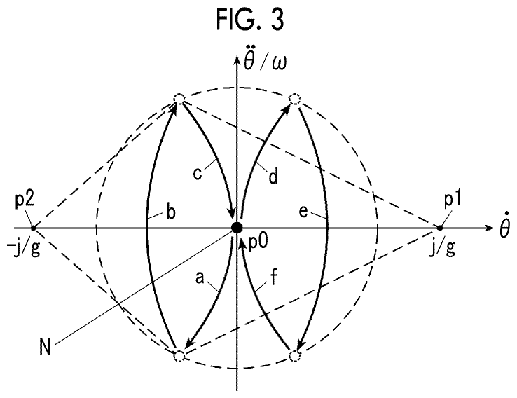

FIGS. 2A and 2B are time charts showing an example of a movement of the boom and an example of the turning drive control command in the swing suppression drive, respectively. FIG. 3 is a phase plane diagram showing the swing suppression drive of FIG. 2. A jerk, the acceleration, and a speed in FIG. 2A represent an actual jerk, actual acceleration, and an actual speed of the tip part of the boom 13 in the turning direction, respectively. The jerk represents a time derivative of acceleration. An acceleration command of FIG. 2B corresponds to an acceleration command obtained by converting the rotating motion of the turning drive device 51 designated by the control command into the acceleration of the tip part of the boom 13. A speed command in FIG. 2B corresponds to a speed command obtained by converting the rotating motion of the turning drive device 51 designated by the control command into the speed of the tip part of the boom 13. The above-described control commands are output from the control unit 40 (specifically, the automatic operation control unit 43) to the turning drive device 51.

As shown in FIG. 2A, the swing suppression drive when the suspended load E is transported in the first direction includes a swing suppression drive M11 during the acceleration and a swing suppression drive M12 during the deceleration. The swing suppression drive M11 during the acceleration is a drive in which the jerk changes in a pattern of a plurality of rectangular waves K11 to K13. More specifically, the pattern of the jerk of the swing suppression drive M11 is a pattern in which the three rectangular waves K11 to K13 changing from a positive value to a negative value are consecutive. In this way, in a case where a temporal change in the jerk is set to the pattern of the rectangular waves K11 to K13, as will be described in detail later, it is possible to effectively correct the response delay of the hydraulic motor. Then, an accurate motion of the boom 13 is obtained by the effective correction, and thus it is possible to accurately implement a planned swing suppression effect.

A high level value, a low level value, and a time length of the rectangular waves K11 to K13 of the jerk need only be determined as follows by using a phase plane of FIG. 3. That is, a swing θq (see FIG. 1) of the suspended load E in the first direction can be represented as a circular motion of a phase point N on a predetermined phase plane (a plane in which a horizontal axis is an angular velocity dθq/dt of the swing θq and a vertical axis is a normalized angular acceleration I/O·d²θ/dt² of the swing θq). Here, d/dt is a time derivative (indicated by a dot in the drawing), ω is a phase angular velocity of the swing (ω=2π/T), and T is a period of the swing θq, which is determined by a length of the wire rope L suspended from the tip part of the boom 13. The phase point N makes one round in the period T, and the center of the circular motion is an origin p0 of the phase plane when the tip of the boom 13 is stopped or moves at a constant speed. Meanwhile, when a constant jerk “j” or “-j” is added to the tip of the boom 13 in the first direction, the center of the circular motion of the phase point N moves to points p1 and p2 of “j/g” or “-j/g”. Here, g is a gravitational acceleration.

Therefore, as shown in FIG. 3, by appropriately selecting the high level value and the low level value of the rectangular waves K11 to K13 and the time length of the rectangular waves K11 to K13, it is possible to find paths of a plurality of arcs a to f along which the phase point N is displaced from the origin p0 on the phase plane and is returned to the origin p0 again. The arcs a to f are arcs centered on an arbitrary point on the horizontal axis. Further, it is also possible to select the arcs a to f such that the center points of the arcs a, c, and e are equal to each other, the center points of the arcs b, d, and f are equal to each other, and the center angles (corresponding to the time lengths) of the respective arcs a to f are substantially equal to each other. By calculating the rectangular waves K11 to K13 corresponding to the arcs a to f, the rectangular waves K11 to K13 of the swing suppression drive M11 for accelerating from a state where the speed and the acceleration of the swing θq are zero to one direction and transitioning to a state where the speed and the acceleration of the swing θq are zero again can be obtained. The arcs a, c, and e in FIG. 3 respectively correspond to the high level values and the time lengths of the rectangular waves K11 to K13 of the jerk in FIG. 2A, and the arcs b, d, and f in FIG. 3 respectively correspond to the low level values and the time lengths of the rectangular waves K11 to K13 of the jerk in FIG. 2A.

With the swing suppression drive M11 during the acceleration, a motion is obtained in which the speed and the acceleration of the swing θq are stable at zero after the suspended load E is accelerated in the first direction.

The swing suppression drive M12 during the deceleration is a drive in which the jerk changes in a pattern of a plurality of rectangular waves K14 to K16 as shown in FIG. 2A. More specifically, the pattern of the jerk of the swing suppression drive M12 is a pattern in which the three rectangular waves K14 to K16 changing from a negative value to a positive value are consecutive. In this way, in a case where a temporal change in the jerk is set to the pattern of the rectangular waves K14 to K16, as will be described in detail later, it is possible to effectively correct the response delay of the hydraulic motor. Then, an accurate motion of the boom 13 is obtained by the effective correction, and thus it is possible to accurately implement a planned swing suppression effect.

The swing suppression drive M12 during the deceleration performs the same calculation as the swing suppression drive M11 with the positive and negative signs reversed, and thus the rectangular waves K14 to K16 of the jerk corresponding to the path along which the phase point N is displaced from the origin p0 on the phase plane and is returned to the origin p0 can be obtained. With the swing suppression drive M12 during the deceleration, a motion is obtained in which the speed and the acceleration of the swing θq are stable at zero after the speed of the suspended load E is decelerated in the first direction to zero.

### Correction of Response Delay of Hydraulic Motor

In a case where a control command to directly designate the motions of the swing suppression drives M11 and M12 in FIG. 2A is input as the turning drive control command, an actual turning motion via the turning drive device 51 deviates from the motion in FIG. 2A due to the response delay of the hydraulic motor.

The response delay of the hydraulic motor corresponds to a first-order delay. Therefore, when a system that generates the acceleration based on the control command is expressed by a transfer function, the system is expressed by Expression (1).

$$N ( s ) = 1 / ( Td \cdot s + 1 ) \cdot U ( s ) \qquad ( 1 )$$

Here, U(s) is an acceleration control command, N(s) is actual acceleration, s is a complex frequency, and Td is a coefficient indicating the magnitude of the response delay. The coefficient Td is a constant that depends on a structure of the hydraulic motor or the mechanism, and can be obtained by an experiment or a simulation.

Here, in a case where there is a response delay, and the control command U(s) in which the actual acceleration coincides with planned acceleration N(s) is obtained, U(s) is expressed by Expression (2).

$$U ( s ) = ( Td \cdot s + 1 ) N ( s ) \qquad ( 2 )$$

When Expression (2) is returned to the time space, Expression (3) is obtained.

$$u ( t ) = Td \cdot d ( n ( t ) ) / dt + n ( t ) \qquad ( 3 )$$

Here, u (t) is an acceleration control command in the time space, and n (t) is actual acceleration in the time space. Therefore, dn(t)/dt is the jerk in the time space.

In Expression (3), when the jerk is constant, the right side first term “Td· d (n (t))/dt” is a constant. Further, when the jerk is constant, the response delay can be effectively corrected by a value of the acceleration control command u(t), and the accurate acceleration control of the turning drive device 51 can be implemented.

The swing suppression drives M11 and M12 shown in FIG. 2A are drives in which the jerk changes in the pattern of a plurality of rectangular waves K11 to K13 and K14 to K16. Therefore, the swing suppression drives M11 and M12 correspond to a drive in which a constant drive is repeated in a plurality of sections, and it is possible to perform an effective correction of the response delay by correcting the response delay using Expression (3). Therefore, it is possible to accurately control the acceleration of the turning drive device 51 by using the swing suppression drives M11 and M12, and it is possible to accurately suppress the swing of the suspended load E.

The value of the corrected acceleration control command is a value obtained by adding the jerk x the coefficient Td to a target acceleration. Therefore, as shown in FIG. 2B, the acceleration control command includes a control command of a pattern for swing suppression P11 corresponding to the swing suppression drive M11 and a control command of a pattern for swing suppression P12 corresponding to the swing suppression drive M12.

The pattern for swing suppression P11 includes a plurality of modified triangular waves H11 to H13 in which a first gradient portion q1 that changes with a first gradient (corresponding to a predetermined gradient) in the positive direction, an offset portion q2 in which a control value is displaced in a direction opposite to the change in the first gradient portion q1, and a second gradient portion q3 that changes with a second gradient (corresponding to the predetermined gradient) in the direction opposite to the change in the first gradient portion q1 are consecutive. Similarly, the pattern for swing suppression P12 includes a plurality of modified triangular waves H14 to H16 in which a first gradient portion q5 that changes with the first gradient, an offset portion q6 in which a control value is displaced in the direction opposite to the change in the first gradient portion q5, and a second gradient portion q7 that changes with a second gradient in a direction opposite to the change in the first gradient portion q5 are consecutive. The displacement in the offset portions q2 and q6 means that a value is abruptly changed at a certain time, and the displacement includes displacement in which a value is discretely changed and displacement in which a value is changed in a steep slope in an extremely short time. The same applies to the displacement or the change in the offset portion described below.

The modified triangular waves H11 to H13 may be regarded as a waveform including the offset portion q0 that changes in the same direction as the change in the first gradient portion q1 in the preceding stage of the first gradient portion q1 and in which the offset portion q0, the first gradient portion q1, the offset portion q2, and the second gradient portion q3 are consecutive. Similarly, the modified triangular waves H14 to H16 may be regarded as a waveform including the offset portion q4 that changes in the same direction as the change in the first gradient portion q5 in the preceding stage of the first gradient portion q5 and in which the offset portion q4, the first gradient portion q5, the offset portion q6, and the second gradient portion q7 are consecutive.

In Embodiment 1, an absolute value of a gradient of the first gradient portion q1 and an absolute value of a gradient of the second gradient portion q3 are the same as each other. In addition, an absolute value of a gradient of the first gradient portion q5 and an absolute value of a gradient of the second gradient portion q7 are the same as each other. In addition, the absolute value of the gradient of the first gradient portion q1 of the modified triangular wave H11 and the absolute value of the gradient of the first gradient portion q5 of the modified triangular wave H14 are the same as each other. Further, the three modified triangular waves H11 to H13 have the same shape and size, and the three modified triangular waves H14 to H16 have the same shape and size. The offset amounts of the offset portions q0 and q4, the gradients of the first gradient portions q1 and q5, the offset amounts of the offset portions q2 and q6, and the gradients of the second gradient portions q3 and q7 may have different magnitudes in each of the plurality of modified triangular waves H11 to H16.

A control command to designate the turning motion in FIG. 2B is input from the control unit 40 (specifically, the automatic operation control unit 43) to the turning drive device 51, so that the turning motion in FIG. 2A occurs. Then, the swing of the suspended load E can be reduced during the acceleration or deceleration while the suspended load E is being transported in the first direction, and thus the transport can be implemented in which the swing of the suspended load E after the transport is reduced.

In Embodiment 1, the example has been described in which the first direction in which the suspended load E is transported is the turning direction q (see FIG. 1), but the first direction in which the suspended load E is transported may be the derricking direction r (see FIG. 1) perpendicular and horizontal to the turning direction q. In this case, the same control as the control of the turning drive device 51 of Embodiment 1 need only be performed on the derricking drive device 52. In addition, when the first direction in which the suspended load E is transported is a composite direction of the directions q and r, both the turning drive device 51 and the derricking drive device 52 need only be controlled such that the motion in FIG. 2A is obtained as a motion in the composite direction. Alternatively, the swing of the suspended load E in the turning direction q and the swing of the suspended load E in the derricking direction r may be independently treated, and the same control as in Embodiment 1 may be independently performed on the turning drive device 51 and the derricking drive device 52. By these controls, the same swing suppression drive can be implemented even when the suspended load E is transported in any direction.

As described above, with the swing suppression drives M11 and M12 of Embodiment 1, the swing of the suspended load E can be reduced while the suspended load E is being transported. The positive and negative signs of the waveforms shown in FIGS. 2A and 2B may all be reversed, and, in this case, the turning motion in the opposite direction occurs.

Further, the swing suppression drive M11 of Embodiment 1 corresponds to a drive in which the jerk of the boom 13 changes in the pattern of the three rectangular waves K11 to K13. Similarly, the swing suppression drive M12 of Embodiment 1 corresponds to a drive in which the jerk of the boom 13 changes in the pattern of the three rectangular waves K14 to K16. The acceleration control command for implementing such swing suppression drives M11 and M12 includes a control command in which the acceleration command value changes in the pattern for swing suppression P11 in which the three modified triangular waves H11 to H13 are consecutive, and a control command in which the acceleration command value changes in the pattern for swing suppression P12 in which the three modified triangular waves H14 to H16 are consecutive. With such a configuration, the path of the phase point N in FIG. 3 can be adopted, and thus the three rectangular waves K11 to K13 included in the drive pattern of the boom 13 and the three modified triangular waves H11 to H13 included in the control command can have the same waveform. In this manner, the motion of the boom 13 of the swing suppression drive M11 can be regarded as a repetition of similar acceleration changes, and thus effective swing suppression can be implemented by a stable drive of the boom 13 with the power applied to the boom 13 in a time direction. The same applies to the swing suppression drive M12 during the deceleration and the pattern for swing suppression P12 during the deceleration. In addition, when the swing suppression drive M11 during the acceleration is changed from the drive including the three rectangular waves K11 to K13 to a drive including more than three rectangular waves, the control becomes complicated, and the movement of the boom 13 also becomes complicated. However, in the present embodiment, with the drive including the three rectangular waves K11 to K13, effective swing suppression can be implemented with a relatively simple control and operation. The same applies to the swing suppression drive M12 during the deceleration. The number of times the modified triangular wave is repeated consecutively a plurality of times from a state where the boom 13 is stopped to a state where the boom 13 accelerates to a predetermined constant speed or from a state where the boom 13 is at the constant speed to a state where the boom 13 starts to decelerate to stop is three times. By setting such a number of times, effective swing suppression can be implemented with relatively simple control and operation.

Further, with the control command having the swing suppression drives M11 and M12 and the patterns for swing suppression P11 and P12 of Embodiment 1, the swing is significantly reduced after the acceleration via the swing suppression drive M11. Therefore, there are few constraints on the time to start the swing suppression drive M12 during the deceleration. A period from an ending point of the swing suppression drive M11 to a starting point of the swing suppression drive M12 is a time during which the suspended load E moves at a certain speed, and a movement distance of the suspended load E can be adjusted by changing a length of the period. Therefore, with the swing suppression drives M11 and M12 of Embodiment 1, a distance for transporting the suspended load E can be easily set.

### Embodiment 2

Subsequently, a swing suppression drive of Embodiment 2 will be described in which the swing suppression is performed on the spot without largely moving the suspended load E. The swing suppression drive is performed by the swing suppression mode operation control unit 44 when the operator selects the swing suppression mode.

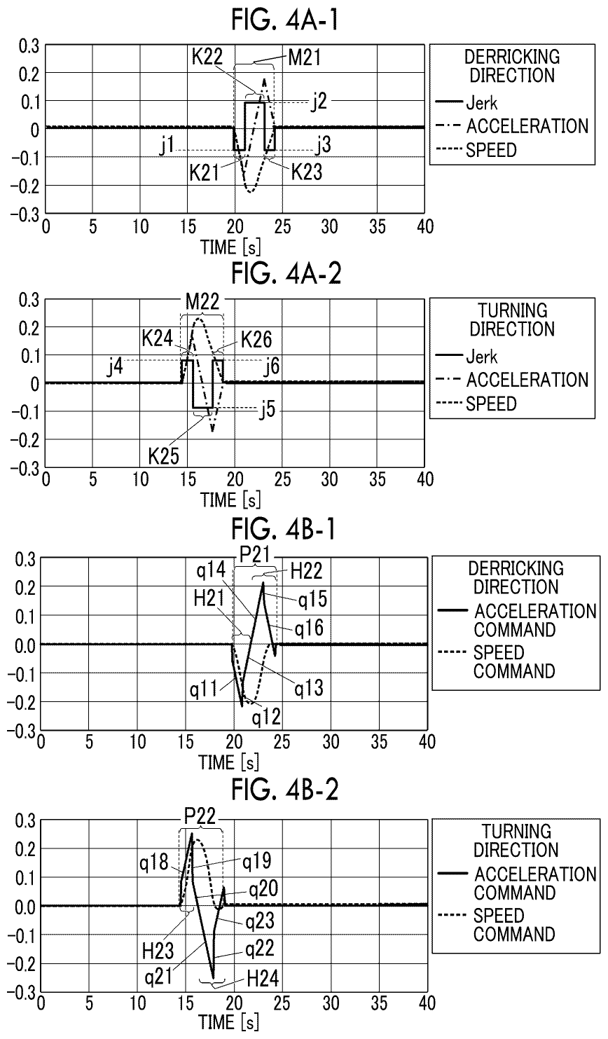

FIGS. 4A-1 and 4A-2 and 4B-1 and 4B-2 are time charts showing examples of a movement of a boom and examples of a control command in a swing suppression drive, respectively. FIGS. 4A-1 and 4B-1 show the drive in the derricking direction of the boom 13 and the control command thereof, and FIGS. 4A-2 and 4B-2 show the drive in the turning direction of the boom 13 and the control command thereof.

As shown in FIGS. 4A-1 and 4A-2, the swing suppression drive when the swing of the suspended load E is suppressed on the spot includes a swing suppression drive M21 caused by the derricking of the boom 13 and a swing suppression drive M22 caused by the turning of the boom 13. In Embodiment 2, the swing suppression drives M21 and M22 are performed at different times, but the swing suppression drives M21 and M22 may be performed at overlapping times depending on a period starting point of the swing in each direction.

The swing suppression drive M21 in the derricking direction r is a drive in which the jerk in the derricking direction r changes in a pattern of a plurality of rectangular waves K21 to K23. More specifically, the swing suppression drive M21 is a drive of changing the jerk from zero, in a rectangular wave pattern, to a first value j1 representing a negative jerk, a second value j2 representing a positive jerk, and a third value j3 representing a negative jerk in order and returning to zero. In the example of FIG. 4A-1, the first value j1 is equal to the third value j3, but the first value j1 and the third value j3 may be different values.

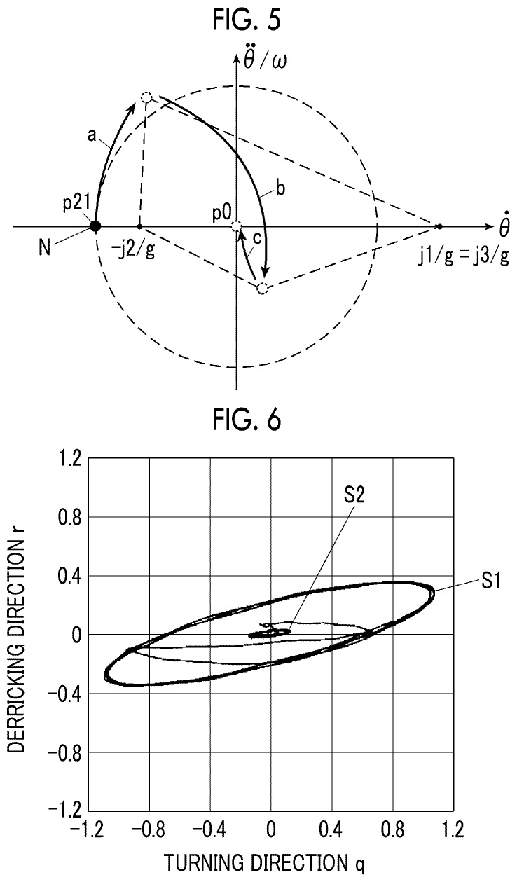

The first value j1 to the third value j3 and the time lengths of the rectangular waves K21 to K23 can be obtained as shown in the phase plane diagram of FIG. 5. That is, as shown in FIG. 5, the three arcs a to c along which the phase point N is returned from a point p21 corresponding to the initial swing to the origin p0 need only be obtained to apply the rectangular waves K21 to K23 having values of the jerk corresponding to the center points and the center angles of the three arcs a to c and the time length. The positive and negative signs of the first value j1 to the third value j3 may be reversed depending on the time of the control, and, in this case, the positive and negative signs of the point p21 are also reversed.

The swing suppression drive M22 in the turning direction q is a drive in which the jerk in the turning direction q changes in a pattern of a plurality of rectangular waves K24 to K26. More specifically, the swing suppression drive M22 is a drive of changing the jerk from zero, in a rectangular wave pattern, to a first value j4 representing a positive jerk, a second value j5 representing a negative jerk, and a third value j6 representing a positive jerk in order and returning the jerk to zero. In the example of FIG. 4A-2, the first value j4 is equal to the third value j6, but the first value and the third value may be different values.

The first value j4 to the third value j6 and the time lengths of the rectangular waves K24 to K26 can be obtained in the same manner as in a case of the swing suppression drive M21 in the derricking direction r described with reference to FIG. 5. The positive and negative signs of the first value j4 to the third value j6 may be reversed depending on the time of the control.

The acceleration control command is a value obtained by adding the jerk x the coefficient Td to the target acceleration, as described above. Therefore, as shown in FIGS. 4B-1 and 4B-2, the control command of the jerk in the derricking direction r of the boom 13 and the control command of the jerk in the turning direction q of the boom 13 are commands including the control commands of the patterns for swing suppression P21 and P22 corresponding to the swing suppression drives M21 and M22.

The pattern for swing suppression P21 is a pattern in which a first modified triangular wave H21 in which a first gradient portion q11 that changes with the first gradient in the negative direction, an offset portion q12 in which the control value is displaced in a direction opposite to the change in the first gradient portion q11, and a 2a-th gradient portion q13 that changes with a second gradient having a smaller absolute value than the first gradient portion q11 in the direction opposite to the change in the first gradient portion q11 are consecutive is followed by a second modified triangular wave H22 in which a 2b-th gradient portion q14 that changes with the second gradient in the positive direction, an offset portion q15 in which the control value is displaced in a direction opposite to the change in the 2b-th gradient portion q14, and a third gradient portion q16 that changes with a third gradient in a direction opposite to the change in the 2b-th gradient portion q14 are consecutive.

The pattern for swing suppression P22 is a pattern in which a first modified triangular wave H23 in which a first gradient portion q18 that changes with the first gradient, an offset portion q19 in which the control value is displaced in a direction opposite to the change in the first gradient portion q18, and a 2a-th gradient portion q20 that changes with the second gradient having a smaller absolute value than the first gradient portion q18 in the direction opposite to the change in the first gradient portion q18 are consecutive in a positive region is followed by a second modified triangular wave H24 in which a 2b-th gradient portion q21 that changes with the second gradient, an offset portion q22 in which the control value is displaced in a direction opposite to the change in the 2b-th gradient portion q21, and a third gradient portion q23 that changes with the third gradient in the direction opposite to the change in the 2b-th gradient portion q21 are consecutive in a negative region.

The control commands to designate the derricking motion and the turning motion in FIGS. 4B-1 and 4B-2 are input from the control unit 40 (specifically, the swing suppression mode operation control unit 44) to the derricking drive device 52 and the turning drive device 51, so that the derricking motion and the turning motion in FIGS. 4A-1 and 4A-2 occur. The swing of the suspended load E can be suppressed on the spot by using the motion.

FIG. 6 is a view showing the swing of the suspended load E based on the swing suppression drive of FIG. 4. In FIG. 6, a vertical axis indicates a position in the derricking direction r, and a horizontal axis indicates a position in the turning direction q. The suspended load E, which has swung along a large elliptical trajectory S1 before the swing suppression drive, swings along a trajectory S2 of small swing due to the above-described swing suppression drives M21 and M22.

As described above, with the control command including the swing suppression drives M21 and M22 and the patterns for swing suppression P21 and P22 of Embodiment 2, the swing of the suspended load E can be reduced on the spot. Further, such an effect can be implemented by a small drive amount of the boom 13. In addition, in Embodiment 2, the number of times the rectangular waves K21 to K23 or the rectangular waves K24 to K26 are repeated consecutively a plurality of times from a state where the boom 13 is stopped to a state where the boom 13 accelerates to a predetermined constant speed or from a state where the boom 13 is at the constant speed to a state where the boom 13 starts to decelerate to stop is three times. By setting such a number of times, effective swing suppression can be implemented with relatively simple control and operation.

### Embodiment 3

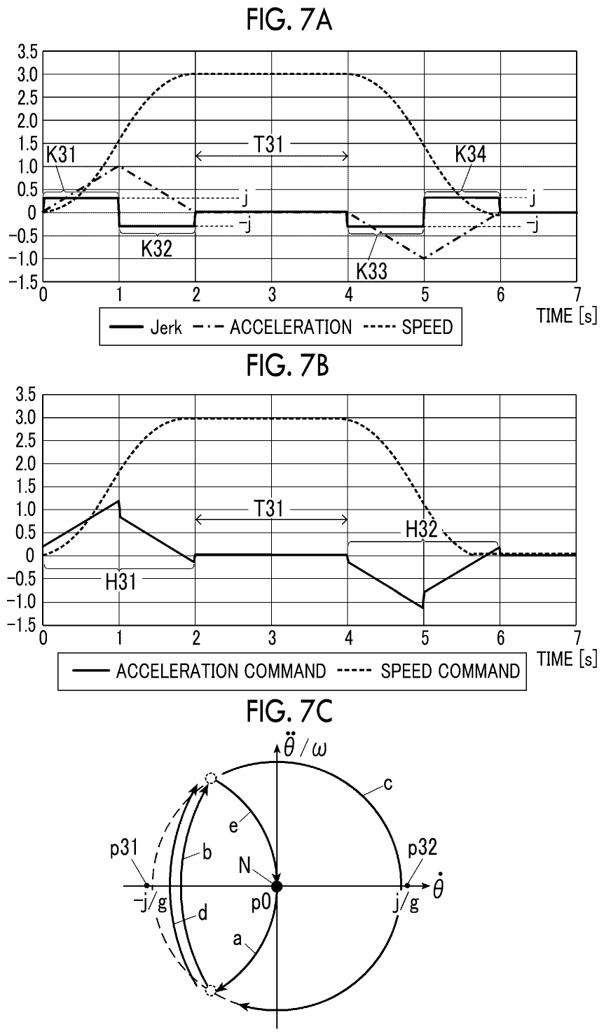

FIG. 7A and FIG. 7B are time charts showing an example of a movement of a boom and an example of a turning drive control command in a swing suppression drive in Embodiment 3, respectively, and FIG. 7C is a phase plane diagram showing an example of a movement of a phase point. The swing suppression drive of Embodiment 3 is a drive of performing the swing suppression while the suspended load E is being transported in the first direction. The swing suppression drive is implemented by the automatic operation control unit 43 by selecting the automatic operation mode after the operator designates the transport destination point.

As shown in FIG. 7A, the swing suppression drive of Embodiment 3 is a drive in which the jerk in the turning direction changes in a pattern of a plurality of rectangular waves K31 to K34. Specifically, the pattern of the swing suppression drive is a pattern in which a positive rectangular wave K31 and a negative rectangular wave K32 are consecutive, and a negative rectangular wave K33 and a positive rectangular wave K34 are consecutive with a period T31 in which the acceleration and the jerk are zero interposed therebetween. Further, in the pattern, high level values “j” of the positive rectangular waves K31 and K34 are equal to each other, low level values “-j” of the negative rectangular waves K32 and K33 are equal to each other, and the absolute values of both values are equal to each other.

The high level value or the low level value of the rectangular waves K31 to K34, and the time length thereof and the time length of the period T31 can be obtained as shown in the phase plane diagram of FIG. 7C. That is, as shown in FIG. 7C, a path is obtained in which the phase point N moves along the arcs a and b centered on points p31 and p32 corresponding to the jerks “j” and “-j”, moves along the arc c centered on the origin p0, moves along the arcs d and e centered on the points p31 and p32 again, and then is returned to the origin p0. Then, the rectangular waves K31 to K34 having the values of the jerk corresponding to the center points p31 and p32 of the arcs a to e and the time length corresponding to the center angle need only be applied. In addition, since the arc c mainly affects a transport distance of the suspended load E, the size and the center angle of the arc c need only be determined based on the set transport distance.

The acceleration control command is a value obtained by adding the jerk x the coefficient Td to the target acceleration, as described above. Therefore, as shown in FIG. 7B, the control command for the jerk in the turning direction of the boom 13 includes a control command of the pattern for swing suppression corresponding to the swing suppression drive in FIG. 7A. The pattern for swing suppression is a pattern in which the modified triangular wave H31 protruding in the positive direction and the modified triangular wave H32 protruding in the negative direction are located with the period T31 interposed therebetween.

A control command to designate the turning motion in FIG. 7B is input from the control unit 40 (specifically, the automatic operation control unit 43) to the turning drive device 51, so that the turning motion in FIG. 7A occurs. Then, the swing suppression can be performed while the suspended load E is being transported in the first direction, by using the motion.

As described above, with the swing suppression drive of Embodiment 3, it is possible to reduce the swing of the suspended load E at the transport destination while the suspended load E is being transported. Further, with the swing suppression drive of Embodiment 3, the transport of the suspended load E and the swing suppression can be implemented with a small change in the jerk. As in a case of Embodiment 1, the positive and negative signs of all the jerk waveforms may be reversed, and, in this case, the turning motion in the opposite direction occurs.

### Embodiment 4

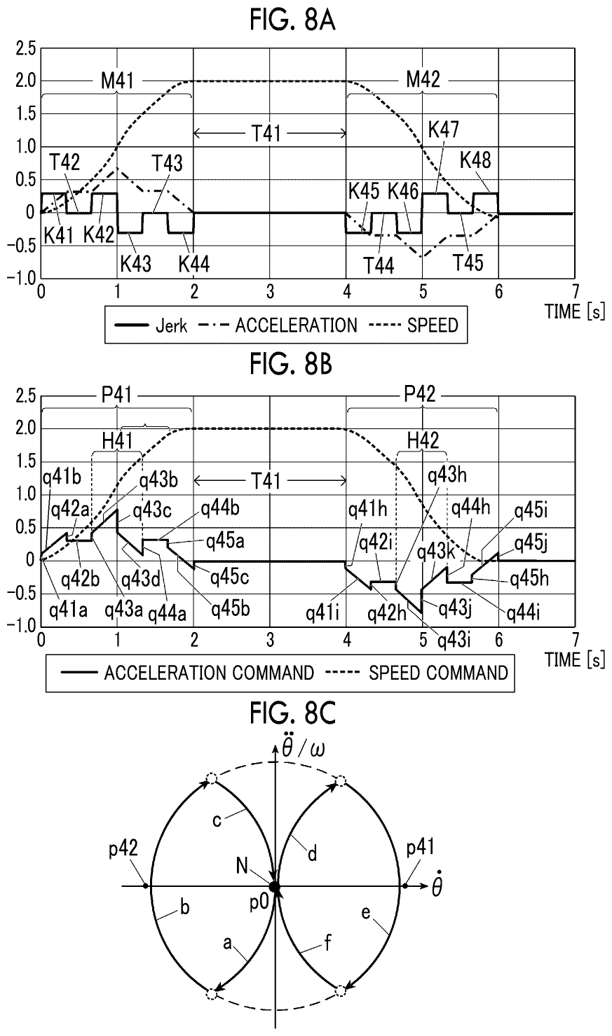

FIG. 8A and FIG. 8B are time charts showing an example of a movement of a boom and an example of a turning drive control command in a swing suppression drive in Embodiment 4, respectively, and FIG. 8C is a phase plane diagram showing an example of a movement of a phase point. The swing suppression drive of Embodiment 4 is a drive of performing the swing suppression while the suspended load E is being transported in the first direction. The swing suppression drive is implemented by the automatic operation control unit 43 by selecting the automatic operation mode after the operator designates the transport destination point.

As shown in FIG. 8A, the swing suppression drive of Embodiment 4 is a drive in which a swing suppression drive M41 during the acceleration and a swing suppression drive M42 during the deceleration are performed with an arbitrary period T41 interposed therebetween. Specifically, the swing suppression drive M41 during the acceleration is a drive in which, as a waveform of the jerk, positive rectangular waves K41 and K42 are located with a period T42 interposed therebetween, and then negative rectangular waves K43 and K44 are located with a period T43 interposed therebetween. The swing suppression drive M42 during the deceleration is a drive in which, as a waveform of the jerk, negative rectangular waves K45 and K46 are located with a period T44 interposed therebetween, and then positive rectangular waves K47 and K48 are located with a period T45 interposed therebetween.

The high level values of the positive rectangular waves K41, K42, K47, and K48 and the low level values of the negative rectangular waves K43, K44, K45, and K46 are set such that the absolute values thereof are equal to each other, but one or more of the positive rectangular waves K41, K42, K47, and K48 and the negative rectangular waves K43, K44, K45, and K46 may be set such that the absolute values thereof are different from each other. The time lengths of the rectangular waves K41 to K48 are set to be the same as each other, but one or more of the time lengths may be set to have a difference from the other time lengths.

The high level value or the low level value of the rectangular waves K41 to K44 and the time length thereof, and the time length of the periods T42 and T43 can be obtained as shown in the phase plane diagram of FIG. 8C. That is, as shown in FIG. 8C, the arcs a to e need only be obtained in which the phase point N moves along the arcs a to e from the origin p0 and is returned to the origin p0. Here, the arcs a, c, d, and f are arcs centered on points p41 and p42 corresponding to the values of the jerk. The arcs b and e are arcs centered on the origin p0. When the arcs a to e are determined, the values and the periods of the rectangular waves K41 to K44 and the periods T42 and T43 need only be determined from the values of the jerk corresponding to the points p41 and p42 and the time lengths corresponding to the center angles. The high level value or the low level value of the rectangular waves K45 to K48 and the time length thereof, and the time length of the periods T44 and T45 can also be obtained in the same manner.

The acceleration control command is a value obtained by adding the jerk x the coefficient Td to the target acceleration, as described above. Therefore, as shown in FIG. 8B, the control command of the jerk in the turning direction of the boom 13 is a pattern in which a pattern for swing suppression P41 during the acceleration and a pattern for swing suppression P42 during the deceleration are located with the period T41 interposed therebetween.

The pattern for swing suppression P41 during the acceleration is a pattern in which the control value changes in order along an offset portion q41a that is offset in the positive direction, a first gradient portion q41b that changes with a first gradient in the positive direction, an offset portion q42a that is offset in the negative direction, a flat portion q42b having a constant value, an offset portion q43a that is offset in the positive direction, a second gradient portion q43b that changes with a second gradient in the positive direction, an offset portion q43c that is offset in the negative direction, a third gradient portion q43d that changes with a third gradient in the negative direction, an offset portion q44a that is offset in the positive direction, a flat portion q44b having a constant value, an offset portion q45a that is offset in the negative direction, a fourth gradient portion q45b that changes with a fourth gradient in the negative direction, and an offset portion q45c that is offset in the positive direction. The pattern includes a modified triangular wave H41 (the second gradient portion q43b, the offset portion q43c, and the third gradient portion q43d) protruding in the positive direction.

The pattern for swing suppression P42 during the deceleration is a pattern in which the control value changes in order along an offset portion q41h that is offset in the negative direction, a fifth gradient portion q41i that changes with a fifth gradient in the negative direction, an offset portion q42h that is offset in the positive direction, a flat portion q42i having a constant value, an offset portion q43h that is offset in the negative direction, a sixth gradient portion q43i that changes with a sixth gradient in the negative direction, an offset portion q43j that is offset in the positive direction, a seventh gradient portion q43k that changes with a seventh gradient in the positive direction, an offset portion q44h that is offset in the negative direction, a flat portion q44i having a constant value, an offset portion q45h that is offset in the positive direction, an eighth gradient portion q45i that changes with an eighth gradient in the positive direction, and an offset portion q45j that is offset in the negative direction. The pattern includes a modified triangular wave H42 (the sixth gradient portion q43i, the offset portion q43j, and the seventh gradient portion q43k) protruding in the negative direction.

Here, the absolute values of the first gradient to the eighth gradient are the same as each other, but one or more of the first gradient to the eighth gradient may have an absolute value different from the others. The time lengths of the first gradient portion q41b to the eighth gradient portion q45i are set to be the same as each other, but one or more of the time lengths may be different from the others.

The control command of FIG. 8B is input from the control unit 40 (specifically, the automatic operation control unit 43) to the turning drive device 51, so that the turning motion of FIG. 8A occurs. Then, the swing suppression can be performed while the suspended load E is being transported in the first direction, by using the motion.

As described above, with the swing suppression drive of Embodiment 4, the swing suppression of the suspended load E can be implemented after the acceleration and during the deceleration to stop while the suspended load E is being transported. Further, with the swing suppression drive of Embodiment 4, since the swing after the acceleration is zero due to the swing suppression drive M41 during the acceleration, the time to start the swing suppression drive M42 during the deceleration can be freely set thereafter. The distance for transporting the suspended load E is a function of a period from an ending point of the swing suppression drive M41 to a starting point of the swing suppression drive M42. Therefore, with the swing suppression drives M41 and M42 of Embodiment 4, a distance for transporting the suspended load E can be easily set. As in a case of Embodiment 1, the positive and negative signs of all the jerk waveforms may be reversed, and, in this case, the turning motion in the opposite direction occurs.

### Embodiment 5

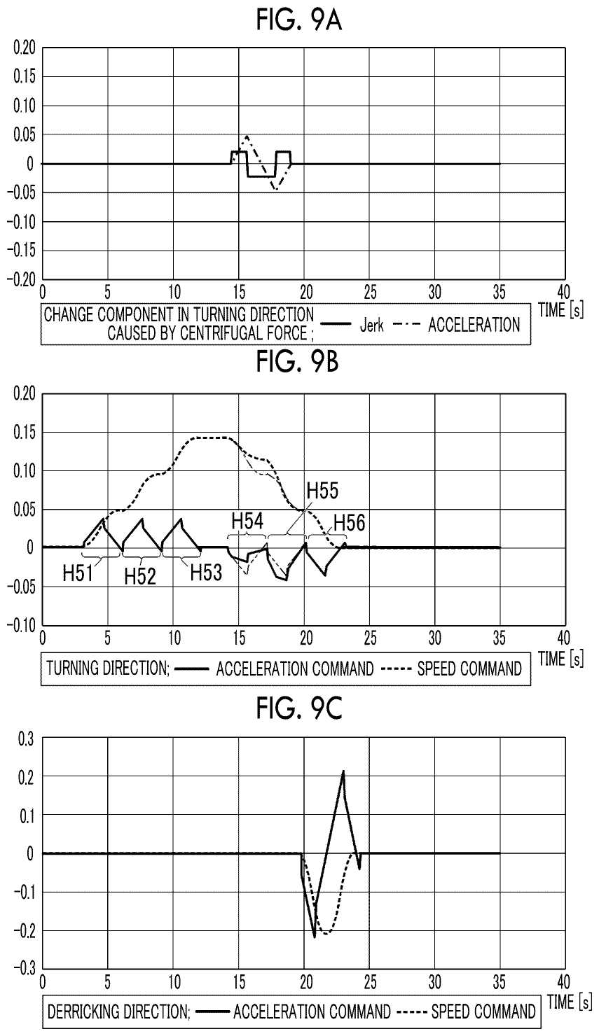

FIGS. 9A to 9C are time charts showing a swing suppression drive of Embodiment 5. The swing suppression drive of Embodiment 5 shows an example of the swing suppression drive when the boom 13 turns at a relatively large angle or at a fast speed. In a large-angle turning, the swing motion in the derricking direction r occurs due to the centrifugal force. As a result, the swing motion in the turning direction q is changed (a change in a magnitude and a phase). The swing suppression drive of Embodiment 5 is obtained by mixing the swing suppression drive for a change component of the swing motion in the turning direction q (FIG. 9A) in addition to the swing suppression drive in the turning direction q of Embodiment 1 (FIG. 2A). Further, the swing suppression drive of Embodiment 5 is also a swing suppression drive of reducing the swing in the derricking direction r caused by the centrifugal force.

FIG. 9A is a time chart showing a swing suppression drive of reducing the swing of the change component of the motion in the turning direction q caused by the centrifugal force. FIG. 9B is a time chart showing a turning drive control command, and corresponds to a control command in which a control command when the centrifugal force is ignored and a control command of the change component in FIG. 9A are linearly combined. FIG. 9C is a time chart showing a derricking drive control command. In FIG. 9B, the control command when the centrifugal force is ignored is shown by a two-dot chain line, and the control command of the two-dot chain line is the same as the control command in FIG. 2B.

The swing suppression drive of Embodiment 5 is obtained by combining the swing suppression drive of Embodiment 2 and the swing suppression drive of Embodiment 1. Therefore, the control command of Embodiment 5 is a command in which the control command of Embodiment 2 and the control command of Embodiment 1 are combined. The above-described combination means a linear combination.

A pattern of the swing suppression drive of Embodiment 5 can be obtained as follows. That is, first, as shown in Embodiment 1, the swing suppression motion in the turning direction q is calculated by ignoring the influence of the centrifugal force. Next, the swing suppression motions of reducing, on the spot, the swing in the derricking direction r caused by the influence of the centrifugal force and the swing of the change component in the turning direction q are calculated as shown in Embodiment 2. Then, the swing suppression motion of Embodiment 5 can be obtained by combining these swing suppression motions. Although not shown, since the combination is performed, the swing suppression drive in the turning direction q of Embodiment 5 also has a pattern in which the jerk changes along the plurality of rectangular waves. Similarly, the swing suppression drive in the derricking direction r of Embodiment 5 also has a pattern in which the jerk changes along the plurality of rectangular waves. In addition, as shown in FIG. 9B, the turning drive control command is a pattern in which a plurality of modified triangular waves H51 to H53 and H54 to H56 are consecutive, including the combined portion. The derricking drive control command has the same pattern as in Embodiment 2, as shown in FIG. 9C.

The turning drive control command in FIG. 9B and the derricking drive control command in FIG. 9C are input to the turning drive device 51 and the derricking drive device 52, respectively, from the control unit 40 (specifically, the automatic operation control unit 43), so that it is possible to perform the swing suppression in the two directions of the turning direction q and the derricking direction r while the suspended load E is being transported.

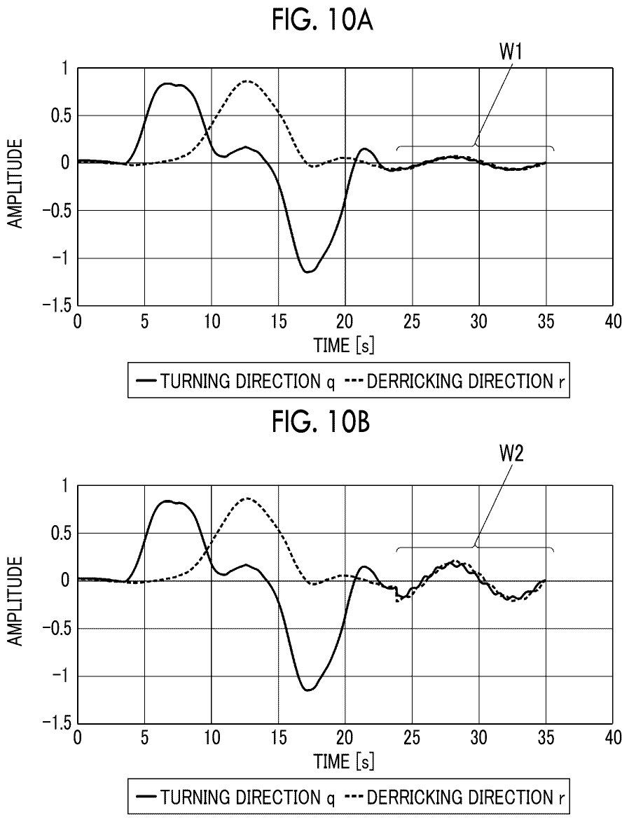

FIGS. 10A and 10B are time charts showing an example of a motion of the suspended load E via the swing suppression drive in Embodiment 5 and an example of the motion of the suspended load E when the swing suppression drive ignoring the centrifugal force is performed, respectively. When the turning angle is large and a large centrifugal force is applied to the suspended load E, a relatively large residual swing W2 remains in the suspended load E in a case where the swing suppression drive that does not consider the centrifugal force is performed. On the other hand, by performing the swing suppression drive of Embodiment 5 in consideration of the centrifugal force, it is possible to reduce a residual swing W1 of the suspended load E.

Each embodiment of the present invention has been described above. However, the present invention is not limited to the above-described embodiment. For example, in the above-described embodiment, the change in the jerk of the tip part of the boom 13 in the pattern of the rectangular wave has been described. However, the rectangular wave is not limited to a strict rectangular wave, and, for example, may include a sufficiently small (for example, 3% or less) rise time or fall time with respect to the period T of the swing, or may include a roundness for a sufficiently small (for example, 5% or less) period at a rectangular corner portion with respect to the period T of the swing. The rise time and the fall time mean a time of a section of 10% to 90% from a lower end to an upper end of each rectangular wave.

In the above-described embodiment, several patterns in which each gradient or the absolute value of each gradient is the same for the plurality of gradient portions included in the drive command of the pattern for swing suppression have been described. However, the term “same” is not limited to “strictly the same”, and a range including a small error may be regarded as the same. For example, when the average of the gradient values of the acceleration [m/s²]/time[s] in each of the two gradient portions is in a range of +10 percent, +20 percent, or +30 percent with respect to each other, the gradients of the two gradient portions may be regarded as being the same as each other. In theory, in a case where the residual swing of the suspended load E becomes zero when the gradients are the same, even when the above-described error is included, the residual swing of the suspended load E can be sufficiently reduced. However, the smaller the error is, the smaller the residual swing is.

In the above-described embodiment, the crane 1 in which the boom 13 can be driven in the turning direction q and in the derricking direction r has been described. However, the present invention can be similarly applied to a crane in which the boom 13 can be driven in only one direction. In addition, the present invention can be similarly applied to a crane in which a boom is extendable and retractable in addition to the drives of the turning and the derricking. In addition, the boom may have a configuration including a first boom that is connected to the rotating platform to be capable of being derricked, and a second boom (for example, a jib) that is connected to the first boom to be capable of being derricked.

In the above-described embodiment, the configuration has been described in which the hydraulic motor, as the drive device 50 of the boom 13, generates driving power, and the hydraulic motor is controlled by the pilot signal of the hydraulic pressure. However, the present invention can be applied to a configuration in which, for example, the pilot signal for controlling the opening degree of the control valve is an electric signal, or can be applied to a configuration in which an electric motor is used instead of the hydraulic motor. In addition, in the above-described embodiment, the configuration has been described in which the drive device 50 performs the feedforward-control and the feedback-control to drive the boom 13, but the drive device according to the embodiment of the present invention may be configured to perform only the feedback-control, or may be configured to not involve the feedforward-control and the feedback-control.

In addition, in the above-described embodiment, the crawler crane has been described as an example of the crane 1, but the present invention is not limited to this, and the present invention can be applied to all cranes that transport the suspended load by driving the boom that suspends the suspended load, such as a tower crane, a ceiling crane, a jib crane, a retractable crane, a stacker crane, a portal crane, and an unloader, in addition to other mobile cranes such as a wheel crane, a truck crane, a rough terrain crane, and an all-terrain crane.

It should be understood that the invention is not limited to the above-described embodiment, but may be modified into various forms on the basis of the spirit of the invention. Additionally, the modifications are included in the scope of the invention.

What is claimed is:

1. A crane comprising:
a boom that suspends a suspended load;
a drive device that drives the boom such that the suspended load moves in a first direction; and
a control unit that controls the drive device,
wherein the control unit inputs a control command including a pattern for swing suppression to the drive device, to cause the drive device to execute a swing suppression drive of reducing a swing of the suspended load, and
when a value of the control command is converted into a command value of acceleration of the boom,
the pattern for swing suppression includes a modified triangular wave including, in consecutive order, a first gradient portion that changes with a predetermined gradient in either a positive or negative direction, an offset portion in which the command value is displaced in a direction opposite to the change in the first gradient portion, and a second gradient portion that changes with a predetermined gradient in the direction opposite to the change in the first gradient portion.

2. A crane comprising:
a boom that suspends a suspended load; and
a drive device that drives the boom such that the suspended load moves in a first direction,
wherein the drive device executes a swing suppression drive in which a jerk of the boom changes in a pattern of a plurality of rectangular waves, to reduce a swing of the suspended load.

3. The crane according to claim 1, further comprising:
a detection device that detects the swing of the suspended load;
an operation manipulation unit that is manipulatable by an operator; and
an input/output unit that outputs information to the operator and inputs information from the operator.

4. The crane according to claim 3,
wherein the detection device transmits detection information on the swing of the suspended load to the control unit, and
the detection information is video data.

5. The crane according to claim 3,
wherein the operation manipulation unit includes an operation lever for manually performing a turning operation of a rotating platform, a derricking operation of the boom, and a raising/lowering operation of a hook.

6. The crane according to claim 5,
wherein the operation manipulation unit further includes an automatic operation start manipulation unit for the crane to transition to an automatic operation mode, and a swing suppression mode transition manipulation unit for the crane to transition to a swing suppression mode.

7. The crane according to claim 3,
wherein the input/output unit includes a notification unit that notifies the operator of information via display or sound, and a manipulation panel through which the operator inputs information via manipulation.

8. The crane according to claim 7,
wherein the notification unit receives a command from the control unit to perform a notification operation.

9. The crane according to claim 7,
wherein the manipulation panel receives a display signal from an automatic operation setting processing unit of the control unit, and outputs a manipulation signal to the automatic operation setting processing unit of the control unit.

10. The crane according to claim 1,
wherein the pattern for swing suppression is a pattern in which the modified triangular wave is repeated consecutively a plurality of times.

11. The crane according to claim 10,
wherein the number of times of the plurality of times is three times from a state where the boom is stopped to a state where the boom starts to accelerate to a predetermined constant speed, or from a state where the boom is at the constant speed to a state where the boom starts to decelerate to stop.

12. The crane according to claim 1,
wherein the pattern for swing suppression is a pattern in which a first modified triangular wave in which the first gradient portion that changes with the first gradient in either the positive or negative direction, an offset portion in which a control value is displaced in the direction opposite to the change in the first gradient portion, and a 2a-th gradient portion that changes with a second gradient having a smaller absolute value than the first gradient in the direction opposite to the change in the first gradient portion are consecutive is followed by a second modified triangular wave in which a 2b-th gradient portion that changes with the second gradient, an offset portion in which the control value is displaced in a same direction as the change in the first gradient portion, and a third gradient portion that changes with a third gradient in the same direction as the change in the first gradient portion are consecutive.

13. The crane according to claim 2,
wherein the swing suppression drive is a drive of changing the jerk of the boom, in a pattern of rectangular waves a plurality of times, to a first value representing the jerk in a first direction and a second value representing the jerk in a direction opposite to the first direction.

14. The crane according to claim 13,
wherein the number of times of the plurality of times is three times from a state where the boom is stopped to a state where the boom starts to accelerate to a predetermined constant speed, or from a state where the boom is at the constant speed to a state where the boom starts to decelerate to stop.

15. The crane according to claim 2,
wherein the swing suppression drive is a drive of changing the jerk of the boom from zero, in a pattern of three rectangular waves, to a first value representing the jerk in a first direction, a second value representing the jerk in a direction opposite to the first direction, and a third value representing the jerk in the first direction in order, and returning the jerk of the boom to zero.
